(19) United States
(12) Patent Application Publication
(10) Pub. No.: US 2026/0197840 A1
(43) Pub. Date: Jul. 9, 2026

(54) TECHNIQUES FOR DOWNLINK CONTROL INFORMATION (DCI) PIGGYBACKING IN MULTI-LAYER DOWNLINK MULTIPLE INPUT MULTIPLE OUTPUT (MIMO)

(71) Applicant: QUALCOMM Incorporated, San Diego, CA (US)

(72) Inventors: Morteza SOLTANI, San Diego, CA (US); Jing SUN, San Diego, CA (US); Chih-Hao LIU, San Diego, CA (US)

(21) Appl. No.: 19/012,611

(22) Filed: Jan. 7, 2025

(51) Int. Cl. H04W 72/232; H04L 1/00; H04W 72/0453

(52) U.S. Cl. CPC H04W 72/232; H04L 1/0071; H04W 72/0453

(57) ABSTRACT

Methods, systems, and devices for wireless communications are described. In some cases, a network entity may map, as part of a multiplexing procedure, a set of downlink control information (DCI) bits onto a downlink shared channel such that a first subset of the set of DCI bits is mapped to a first set of frequency resources associated with a first spatial layer of multiple spatial layers and such that a second subset of the set of DCI bits is mapped to a second set of frequency resources associated with a second spatial layer of the multiple spatial layers. In such cases, the first set of frequency resources and the second set of frequency resources may be at least partially non-overlapping. Thus, the network entity may transmit, via the downlink shared channel and via the multiple spatial layers, a message comprising the multiplexed set of DCI bits.

### FIELD OF TECHNOLOGY

The following relates to wireless communications, including techniques for downlink control information (DCI) piggybacking in multi-layer downlink multiple input multiple output (MIMO).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include generating a set of downlink control information (DCI) bits, mapping, as part of a multiplexing procedure, the set of DCI bits onto a downlink shared channel such that a first subset of the set of DCI bits is mapped to a first set of frequency resources associated with a first spatial layer of a set of multiple spatial layers and such that a second subset of the set of DCI bits is mapped to a second set of frequency resources associated with a second spatial layer of the set of multiple spatial layers, where the first set of frequency resources and the second set of frequency resources are at least partially non-overlapping, and transmitting, via the downlink shared channel and via the set of multiple spatial layers, a message including the multiplexed set of DCI bits.

A network entity for wireless communications is described. The network entity may include one or more memories storing processor executable code, and one or more processors coupled with the one or more memories. The one or more processors may individually or collectively be operable to execute the code to cause the network entity to generate a set of DCI bits, mapping, as part of a multiplexing procedure, the set of DCI bits onto a downlink share channel such that a first subset of the set of DCI bits is mapped to a first set of frequency resources associated with a first spatial layer of a set of multiple spatial layers and such that a second subset of the set of DCI bits is mapped to a second set of frequency resources associated with a second spatial layer of the set of multiple spatial layers, where the first set of frequency resources and the second set of frequency resources are at least partially non-overlapping, and transmit, via the downlink shared channel and via the set of multiple spatial layers, a message including the multiplexed set of DCI bits.

Another network entity for wireless communications is described. The network entity may include means for generating a set of DCI bits, means for mapping, as part of a multiplexing procedure, the set of DCI bits onto a downlink shared channel such that a first subset of the set of DCI bits is mapped to a first set of frequency resources associated with a first spatial layer of a set of multiple spatial layers and such that a second subset of the set of DCI bits is mapped to a second set of frequency resources associated with a second spatial layer of the set of multiple spatial layers, where the first set of frequency resources and the second set of frequency resources are at least partially non-overlapping, and means for transmitting, via the downlink shared channel and via the set of multiple spatial layers, a message including the multiplexed set of DCI bits.

A non-transitory computer-readable medium storing code for wireless communications is described. The code may include instructions executable by one or more processors to generate a set of DCI bits, mapping, as part of a multiplexing procedure, the set of DCI bits onto a downlink share channel such that a first subset of the set of DCI bits is mapped to a first set of frequency resources associated with a first spatial layer of a set of multiple spatial layers and such that a second subset of the set of DCI bits is mapped to a second set of frequency resources associated with a second spatial layer of the set of multiple spatial layers, where the first set of frequency resources and the second set of frequency resources are at least partially non-overlapping, and transmit, via the downlink shared channel and via the set of multiple spatial layers, a message including the multiplexed set of DCI bits.

In some examples of the method, network entities, and non-transitory computer-readable medium described herein, the first set of frequency resources may be associated with a first portion of a bandwidth part (BWP) associated with the downlink shared channel, the second set of frequency resources may be associated with a second portion of the BWP associated with the downlink shared channel, and the first set of frequency resources and the second set of frequency resources may be at least partially non-overlapping based on the first portion of the BWP and the second portion of the BWP being at least partially non-overlapping.

In some examples of the method, network entities, and non-transitory computer-readable medium described herein, the first portion may be a first half of the BWP and the second portion may be a second half of the BWP.

In some examples of the method, network entities, and non-transitory computer-readable medium described herein, the set of DCI bits may be associated with a set of multiple first codewords and the method, apparatuses, and non-transitory computer-readable medium may include further operations, features, means, or instructions for interleaving the set of DCI bits across a set of multiple second codewords associated with the downlink shared channel to generate a set of interleaved DCI bits, where the first subset of the set of DCI bits includes a first subset of the set of interleaved DCI bits, and where the second subset of the set of DCI bits includes a second subset of the set of interleaved DCI bits.

In some examples of the method, network entities, and non-transitory computer-readable medium described herein, the set of DCI bits being interleaved may be based on a quantity of first codewords in the set of multiple first codewords, a quantity of DCI bits in each of the set of multiple first codewords, or both.

In some examples of the method, network entities, and non-transitory computer-readable medium described herein, a quantity of first codewords in the set of multiple first codewords may be different than a quantity of second codewords in the set of multiple second codewords.

In some examples of the method, network entities, and non-transitory computer-readable medium described herein, the set of multiple spatial layers may be associated with the downlink shared channel and the first spatial layer and the second spatial layer include a subset of spatial layers from the set of multiple spatial layers.

Some examples of the method, network entities, and non-transitory computer-readable medium described herein may further include operations, features, means, or instructions for selecting the subset of spatial layers from the set of multiple spatial layers based on the subset of spatial layers being associated with a set of strongest demodulation reference signal ports out of a set of multiple demodulation reference signal ports associated with the set of multiple spatial layers.

Some examples of the method, network entities, and non-transitory computer-readable medium described herein may further include operations, features, means, or instructions for refraining from mapping the set of DCI bits to one or more other spatial layers of the set of multiple spatial layers.

Some examples of the method, network entities, and non-transitory computer-readable medium described herein may further include operations, features, means, or instructions for transmitting an indication of a mapping rule associated with the first subset of the set of DCI bits being mapped to the first set of frequency resources and the second subset of the set of DCI bits being mapped to the second set of frequency resources, where the first subset of the set of DCI bits may be mapped to the first set of frequency resources and the second subset of the set of DCI bits may be mapped to the second set of frequency resources may be based on transmission of the indication.

In some examples of the method, network entities, and non-transitory computer-readable medium described herein, the indication of the mapping rule may be transmitted via radio resource control signaling or downlink control information signaling.

Some examples of the method, network entities, and non-transitory computer-readable medium described herein may further include operations, features, means, or instructions for receiving an indication of a capability of a user equipment (UE) to support a mapping rule associated with the first subset of the set of DCI bits being mapped to the first set of frequency resources and the second subset of the set of DCI bits being mapped to the second set of frequency resources, where the first subset of the set of DCI bits may be mapped to the first set of frequency resources and the second subset of the set of DCI bits may be mapped to the second set of frequency resources may be based on the capability of the UE.

In some examples of the method, network entities, and non-transitory computer-readable medium described herein, mapping, as part of the multiplexing procedure, a third subset of the set of DCI bits toa third set of frequency resources associated with a third spatial layer of the set of multiple spatial layers, where the first set of frequency resources, the second set of frequency resources, and the third set of frequency resources may be at least partially non-overlapping.

In some examples of the method, network entities, and non-transitory computer-readable medium described herein, the first set of frequency resources and the second set of frequency resources may be non-overlapping.

In some examples of the method, network entities, and non-transitory computer-readable medium described herein, the set of DCI bits may be associated with a single codeword or multiple codewords.

In some examples of the method, network entities, and non-transitory computer-readable medium described herein, a first quantity of bits in the first subset of the set of DCI bits may be equal to a second quantity of bits in the second subset of the set of DCI bits.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for downlink control information (DCI) piggybacking in multi-layer downlink multiple input multiple output (MIMO) in accordance with one or more aspects of the present disclosure.

FIG. 2 shows an example of a wireless communications system that supports techniques for DCI piggybacking in multi-layer downlink MIMO in accordance with one or more aspects of the present disclosure.

FIG. 3 shows examples of resource mapping diagrams that supports techniques for DCI piggybacking in multi-layer downlink MIMO in accordance with one or more aspects of the present disclosure.

FIG. 4 shows an example of a process flow that supports techniques for DCI piggybacking in multi-layer downlink MIMO in accordance with one or more aspects of the present disclosure.

FIGS. 5 and 6 show block diagrams of devices that support techniques for DCI piggybacking in multi-layer downlink MIMO in accordance with one or more aspects of the present disclosure.

FIG. 7 shows a block diagram of a communications manager that supports techniques for DCI piggybacking in multi-layer downlink MIMO in accordance with one or more aspects of the present disclosure.

FIG. 8 shows a diagram of a system including a device that supports techniques for DCI piggybacking in multi-layer downlink MIMO in accordance with one or more aspects of the present disclosure.

FIG. 9 shows a flowchart illustrating methods that support techniques for DCI piggybacking in multi-layer downlink MIMO in accordance with one or more aspects of the present disclosure.

### DETAILED DESCRIPTION

Some wireless communications systems may support multiplexing of downlink control information (DCI) on a physical downlink shared channel (PDSCH) (e.g., a downlink data message), which may be referred to as DCI piggybacking. That is, rather than transmitting DCI over a physical downlink control channel (PDCCH) via a control resource set (CORESET), where a UE blind decodes multiple PDCCH candidates in the CORESET to identify the DCI, a network entity may multiplex the DCI on a PDSCH, thus enabling the UE to identify the DCI without performing blind decoding. For example, for unicast DCI piggybacking, the network entity may multiplex DCI intended for a first UE onto a PDSCH associated with (e.g., specific to) the first UE or, for broadcast, or multicast, DCI piggybacking, the network entity may multiplex multiple DCIs intended for multiple UEs onto a PDSCH broadcast, or multicast, to the multiple UEs. In either case, DCI bits (e.g., of the DCI or the multiple DCIs) multiplexed onto the PDSCH may be mapped to resources of the PDSCH in a spatial domain first, then a frequency domain, then a time domain. However, conventional mapping techniques may not achieve frequency diversity, thus reducing reliability.

Accordingly, techniques described herein support spatial layer-dependent frequency mapping for increased frequency diversity. That is, a network entity may multiplex a set of DCI bits onto a PDSCH by mapping the set of DCI bits to a set of spatial layers first, and then mapping the set of DCI bits associated with each spatial layer to a respective set of frequency resources associated with each spatial layer, where the respective sets of frequency resources associated with the spatial layers are different. For example, a first spatial layer may be associated with a first set of frequency resources and a second spatial layer may be associated with a second set of frequency resources, where the first set of frequency resources and the second set of resources are at least partially non-overlapping. Thus, the network entity may multiplex the set of DCI bits onto the PDSCH based on mapping a first subset of the set of the DCI bits to the first set of frequency resources and mapping a second subset of the set of DCI bits onto the second set of frequency resources.

Aspects of the disclosure are initially described in the context of wireless communications systems. Aspects of the disclosure are then described in the context of a resource allocation diagram and a process flow. Aspects of the disclosure are further illustrated by and described with reference to apparatus diagrams, system diagrams, and flowcharts that relate to techniques for DCI piggybacking in multi-layer downlink MIMO.

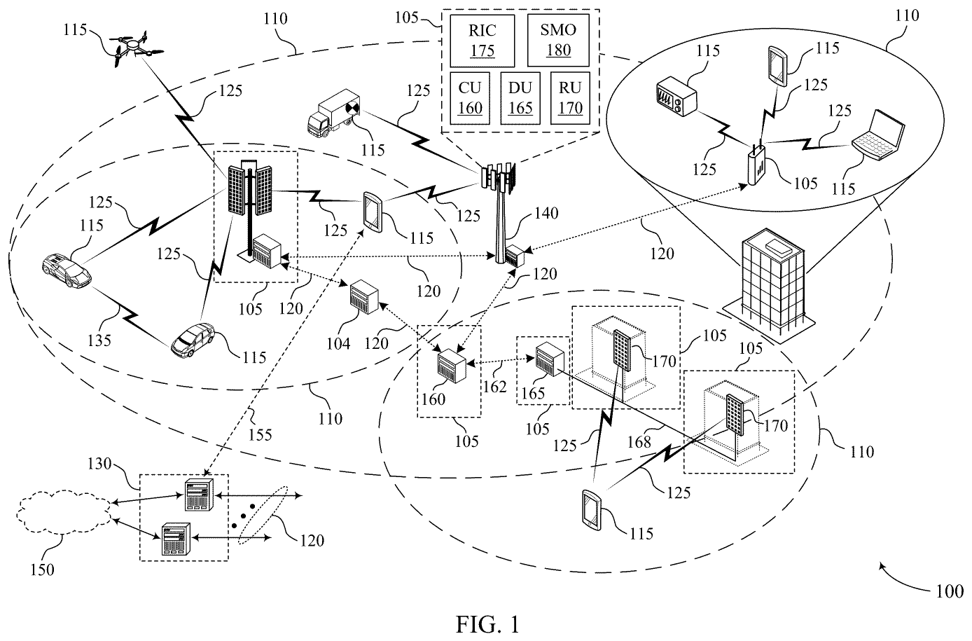

FIG. 1 shows an example of a wireless communications system 100 that supports techniques for DCI piggybacking in multi-layer downlink MIMO in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for DCI piggybacking in multi-layer downlink MIMO as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system may support uplink control information (UCI) multiplexing on PUSCH, which may be referred to as UCI piggybacking on PUSCH. In such cases, the UCI may follow (e.g., have the same) modulation order of the PUSCH. For uplink MIMO (e.g., multi-layer uplink transmissions), a network entity 105 may map UCI and uplink shared channel (UL-SCH) (e.g., uplink data) in an order of spatial layer first, then frequency domain REs second, then time domain OFDM symbols last. In such (e.g., multi-layer uplink MIMO transmissions), the network entity 105 may use layer mapping to distribute modulated symbols (e.g., both UCI and uplink SCH) across multiple layers of transmission. In some cases, the network entity 105 may support up to 8 MIMO layers, where the network entity may support a single codeword (e.g., transport block) for less than or equal to 4 layers and two codewords for greater than 4 layers. In such cases, each of the two codewords may be mapped to, at most, 4 layers and a codeword to layer mapping may be fixed, where the codeword to layer mapping includes a first codeword (e.g., CW0) mapped to a first quantity of layers (e.g., L/2, where L is a total quantity of layers) and a second codeword (e.g., CW1) mapped to a second quantity of layers (e.g., remaining layers).

In some cases, the wireless communications system 100 may support spatial layer-dependent frequency mapping for increased frequency diversity. That is, a network entity 105 may multiplex a set of DCI bits onto a PDSCH by mapping the set of DCI bits to a set of spatial layers first, and then mapping the set of DCI bits associated with each spatial layer to a respective set of frequency resources associated with each spatial layer, where the respective sets of frequency resources associated with the spatial layers are different. For example, a first spatial layer may be associated with a first set of frequency resources and a second spatial layer may be associated with a second set of frequency resources, where the first set of frequency resources and the second set of resources are at least partially non-overlapping. Thus, the network entity 105 may multiplex the set of DCI bits onto the PDSCH based on mapping a first subset of the set of the DCI bits to the first set of frequency resources and mapping a second subset of the set of DCI bits onto the second set of frequency resources.

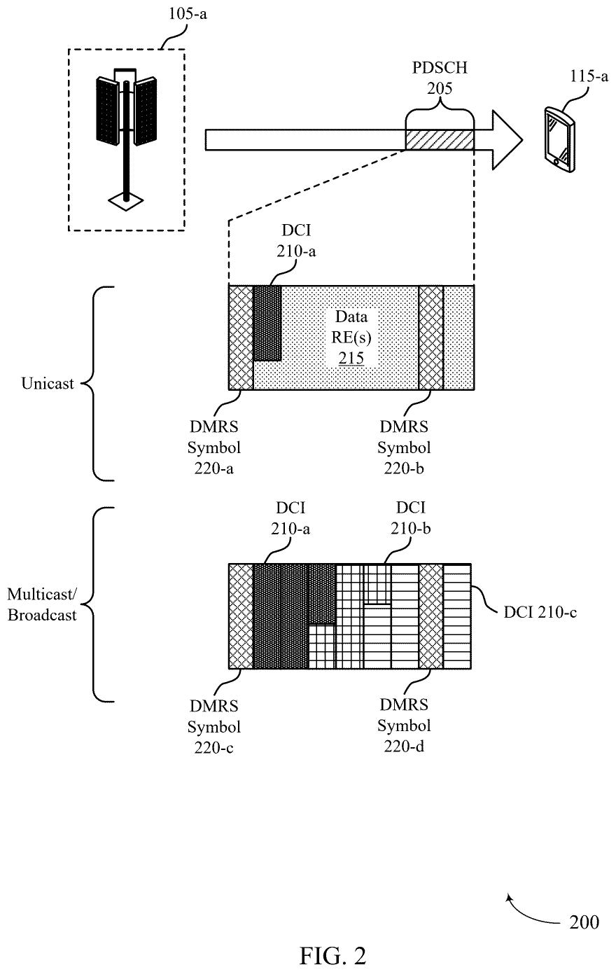

FIG. 2 shows an example of a wireless communications system 200 that supports techniques for DCI piggybacking in multi-layer downlink MIMO in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems (e.g., an NR system), such as the wireless communications system 200, a network entity 105, such as the network entity 105-a, may transmit (e.g., send, output) DCI 210 (e.g., a DCI message) to a UE 115, such as the UE 115-a, where the DCI 210 may indicate control information for the UE 115-a, such as a downlink grant, an uplink grant, or the like thereof. In some examples, the network entity 105-a may transmit the DCI 210 over a PDCCH via a CORESET. In such cases, to identify the DCI 210, the UE 115-a may blind decode multiple PDCCH candidates in the CORESET, where the PDCCH candidates (e.g., blind decoding candidates) are organized in search space sets, and one or more search space sets are associated with the CORESET. In other words, the network entity 105-a may transmit the DCI 210 via the CORESET associated with the one or more search space sets, where each search space set is associated with a PDCCH candidate that the UE 115-a may blind decode to identify (e.g., detect, receive) the DCI 210 (e.g., attempt to identify the DCI 210).

In some cases, blind decoding of PDCCH candidates (e.g., NR PDCCH blind decoding design carried over from LTE PDCCH blind decoding) may support (e.g., be optimized for) multiple UEs 115 being served with a PDCCH at a same time, which may result in reduced blocking between UEs in the CORESET (e.g., the network entity 105-a may randomly hash locations of PDCCH for different UEs, differently in the CORESET). Additionally, or alternatively, the network entity 105-a may perform analog beamforming and resource allocation in accordance with a first communication scheme (e.g., 5G PDCCH), as compared to a second communication scheme (e.g., 4G PDCCH). However, blind decoding may result in increased processing time and thus, higher complexity, for the UE 115-a due to the UE 115-a blind decoding multiple PDCCH candidates.

Accordingly, in some cases, instead of transmitting the DCI 210 via PDCCH, the network entity 105-a may multiplex the DCI 210 on a PDSCH 205 (e.g., on a PDSCH message), which may be referred to as DCI piggybacking, thus enabling the UE 115-a to identify the DCI 210 without performing blind decoding. That is, the network entity 105-a may “piggyback” the DCI 210 (e.g., DCI REs) on the PDSCH 205. For example, for unicast DCI piggybacking, the network entity 105-a may multiplex (e.g., piggyback) a DCI 210-a intended for the UE 115-a (e.g., a unicast standalone DCI 210) onto a unicast PDSCH 205 specific to the UE 115-a (e.g., UE-specific PDSCH 205). That is, the unicast PDSCH 205 may include one or more data resource elements (REs) 215, one or more demodulation reference signal (DMRS) symbols 220, such as a DMRS symbol 220-a and a DMRS symbol 220-b, and the DCI 210-a. In some cases, the network entity 105-a may perform unicast DCI piggybacking during bursty traffic (e.g., for a bursty traffic use case) when the network entity 105-a transmits multiple DCIs 210-a to the UE 115-a at a same time.

Additionally, or alternatively, for broadcast, or multicast, DCI piggybacking, the network entity 105-a may identify (e.g., collect) multiple DCIs 210 for multiple UEs 115, including at least the UE 115-a, and may multiplex (e.g., transmit) the multiple DCIs 210 on a broadcast, or multicast, PDSCH 205. For example, the broadcast, or multicast, PDSCH 205 may include one or more DMRS symbols 220, such as a DMRS symbol 220-c and a DMRS symbol 220-d, and multiple DCIs 210, such as the DCI 210-a associated with the UE 115-a, a DCI 210-b associated with another UE 115, and a DCI 210-c associated with an additional UE 115. In some cases, the broadcast, or multicast, PDSCH 205 may additionally include one or more data REs 215 (e.g., not depicted). In some cases, the network entity 105-a may group UEs 115 to enable the UEs 115 to receive the broadcast, or multicast, PDSCH 205. In other words, the UEs 115 receiving the broadcast, or multicast, PDSCH 205 may support a same set of operational parameters, such as a same modulation and coding scheme (MCS), a same beam, or both, to enable the UEs 115 to receive the broadcast, or multicast, PDSCH 205. Additionally, or alternatively, the network entity 105-a may perform broadcast, or multicast, DCI piggybacking based on communicating via a first frequency range (e.g., FR1), based on supporting a threshold quantity of antennas at the network entity 105-a (e.g., a limited quantity of antennas at the network entity 105-a), based on supporting a threshold quantity of UEs 115 (e.g., being a large cell with multiple users where grouping is easier than with a smaller quantity of users), or any combination thereof. In other words, the network entity 105-a may perform broadcast, or multicast, DCI piggybacking to offload control signaling from PDCCH to PDSCH.

DCI piggybacking (e.g., unicast, broadcast, and multicast) may support a higher efficiency for control information delivery (e.g., as compared to transmitting DCI via PDCCH). That is, DCI piggybacking may result in decreased cyclic redundancy checks (CRC) (e.g., CRC overhead) for aggregated DCIs 210, CRC length reduction (e.g., due to less pruning), higher coding gain with a larger codeword size with aggregated DCIs 210, DMRS sharing with data DMRS, increases in beamforming accuracy (e.g., re-use of data rate control for control signaling with, in some cases, a backoff for higher reliability compared to data, due to lack of retransmission of control signaling), increases in modulation order, or rank, efficiency, and higher diversity level (e.g., sharing data frequency domain interleaving and precoder cycling).

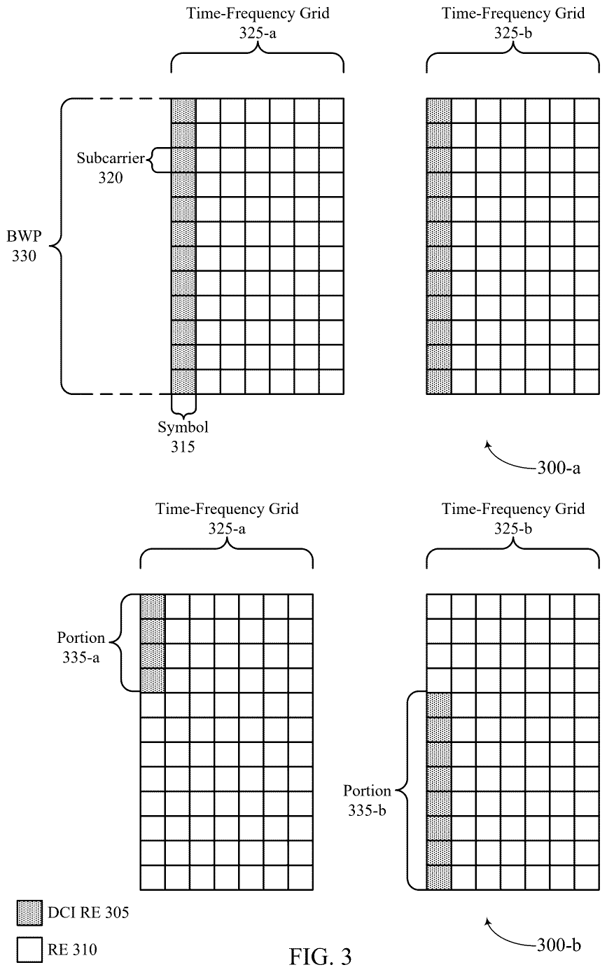

In some examples, the network entity 105-a (e.g., and the UE 115-a) may support MIMO with a Rank greater than 1, such that a PDSCH 205 with piggyback DCI 210 may be transmitted (e.g., communicated) via a multi-layer transmission in a slot. In some cases, the network entity 105-a may rate match data REs 215 (e.g., downlink SCH (DL-SCH) REs) around DCI REs, associated with the piggyback DCI 210, in an order of spatial domain first, then frequency domain, and then time domain, as described with with reference to FIG. 3. In such cases, the order may be preconfigured (e.g., hard coded) at the network entity 105-a. However, rate matching the data REs 215 around the DCI REs may result in a lack of frequency diversity for the DCI REs due to the DCI REs being mapped to MIMO layers (e.g., antenna ports) first, then to frequency domain subcarriers second. Additionally, or alternatively, the network entity 105-a may puncture the DCI REs on the PDSCH 205 (e.g., data REs 215). In some examples, the network entity 105-a may identify (e.g., select) a strongest MIMO layer (e.g., of multiple MIMO layers supported by the network entity 105-a) and may puncture the DCI REs onto data REs 215 on the strongest MIMO layer. In some other cases, the network entity 105-a may puncture the DCI REs onto data REs 215 in all MIMO layers (e.g., of the multiple MIMO layers). However, puncturing the DCI REs onto data REs 215 may decrease (e.g., compromise) performance of the data REs 215 due to the network entity 105-a puncturing the DCI REs on the strongest MIMO layer or across all MIMO layers.

Accordingly, techniques described herein support spatial layer-dependent frequency mapping for increased frequency diversity. That is, with multi-layer downlink transmissions, different MIMO layers (e.g., and correspondingly different antenna ports) may be associated with different channel qualities. As such, the network entity 105-a may distribute modulated symbols of DCI 210 (e.g., DCI REs) on different frequency domains REs on different MIMO layers. Doing so may enable the network entity 105-a to harvest (e.g., achieve, obtain) frequency domain diversity for DCI 210 multiplexed on PDSCH 205 when data REs 215 are rate matched around DCI REs. Similarly, distributing the modulated symbols of the DCI 210 on the different frequency domains REs on the different MIMO layers may provide increased protection and decreased performance degradation of the data REs 215 when DCI REs puncture the data REs 215.

For example, for multi-layer downlink transmissions (e.g., MIMO rank greater than 1) with DCI 210 piggybacked on PDSCH 205, DCI REs (e.g., resources of the DCI 210, modulated symbols of DCI 210, either single codeword or multiple codewords) that are multiplexed onto the PDSCH 205 may depend on a MIMO layer (e.g., antenna port), may be different across different MIMO layers, or both, as described further with reference to FIG. 3. For example, a first MIMO layer may be associated with a first set of frequency resources and a second MIMO layer may be associated with a second set of frequency resources, different from (e.g., at least partially non-overlapping with) the first set of frequency resources, such that the network entity 105-a may multiplex the DCI REs onto the PDSCH 205 by mapping a first subset of the DCI REs to the first set of frequency resources and mapping a second subset of the resources of the DCI 210 onto the second set of frequency resources

In some examples, the network entity 105-a may use a subset of the multiple MIMO layers (e.g., used for DL-SCH transmission) for DCI REs (e.g., DCI resources). That is, a quantity (e.g., number) of MIMO layers used for DCI REs on the PDSCH 205 may be the subset of the multiple MIMO layers used for data REs. In some cases, the network entity 105-a may select the subset (e.g., for mapping DCI modulated symbols on the MIMO layers) based on one or more strongest DMRS ports (e.g., out of all DMRS ports associated with the multiple MIMO layers). Additionally, or alternatively, the network entity 105-a may map the DCI REs to a single strongest MIMO layer (e.g., rank 1 transmission of DCI REs) and may map data REs 215 to all available MIMO layers.

In some examples, the network entity 105-a may signal (e.g., indicate) a configuration of a mapping rule for the multi-layer DCI piggybacking (e.g., on the PDSCH 205) to the UE 115-a. In such cases, the signaling may be semi-static (e.g., via RRC signaling), dynamic (e.g., via a DCI 210 or PDCCH signaling), or both. Additionally, or alternatively, the network entity 105-a (e.g., and the UE 115-a) may be preconfigured with the configuration of the mapping rule (e.g., may be hard-coded). In either case, the configuration of the mapping rule may indicate a subset of available MIMO layers for mapping DCI REs (e.g., a subset of MIMO layers from the available MIMO layers for PDSCH 205), a subset of frequency domain subcarriers for each selected MIMO layer (e.g., a subset of subcarriers from available subcarriers for PDSCH 205), or both. Additionally, or alternatively, the UE 115-a may transmit, to the network entity 105-a, a capability message (e.g., control message) indicative of a capability of the UE 115-a to process the mapping rule for the multi-layer DCI piggybacking.

FIG. 3 shows examples of resource mapping diagrams 300 (e.g., a resource mapping diagram 300-a and a resource mapping diagram 300-b) that supports techniques for DCI piggybacking in multi-layer downlink MIMO in accordance with one or more aspects of the present disclosure. In some cases, the resource mapping diagrams 300 may implement or be implemented by aspects of the wireless communications system 100, the wireless communications system 200, or both. For example, the resource mapping diagrams 300 may be implemented by one or more UEs 115, one or more network entities 105, or both, which may be examples of the corresponding devices as described herein.

As described with reference to FIG. 2, in some cases, a wireless communications system may support mapping of DCI REs 305 (e.g., that are multiplexed onto PDSCH) in an order of spatial domain first, then frequency domain second, then time domain third. For example, a set of modulated symbols 315 of DCI (e.g., complex-valued modulation symbols) for a codeword, q, (e.g., a codeword with a codeword index of q) may be represented according to the following Equation 1:

$${d}^{( q )} ( 0 ) , … , {d}^{( q )} ( {M}_{symb}^{( q )} - 1 ) \qquad ( 1 )$$

where

$${M}_{s y m b}^{( q )}$$

may represent a quantity of modulation symbols 315 in the codeword. The network entity 105 may map the codeword, q, onto layers x(i), which may be represented (e.g., as a block of vectors) according to the following Equation 2:

$$x ( i ) = {[ {x}^{( 0 )} ( i ) … {x}^{( v - 1 )} ( i ) ]}^{T} , i = 0 , 1 , … , {M}_{s y m b}^{layer} - 1 = [ \begin{matrix}{x}^{( 0 )} ( 0 ) & {x}^{( 0 )} ( 1 ) & … & {x}^{( 0 )} ( {M}_{s y m b}^{layer} - 1 ) \\ {x}^{( 1 )} ( 0 ) & {x}^{( 1 )} ( 1 ) & … & {x}^{( 1 )} ( {M}_{s y m b}^{layer} - 1 ) \\ … & … & … & … \\ {x}^{( v - 1 )} ( 0 ) & {x}^{( v - 1 )} ( 1 ) & … & {x}^{( v - 1 )} ( {M}^{layer} - 1 )\end{matrix} ] \qquad ( 2 )$$

where v may represent a quantity of layers (e.g., MIMO layers) and

$${M}_{s y m b}^{layer}$$

may represent a quantity of modulation symbols per layer.

In some cases, as described with reference to the resource mapping diagram 300-a, for two layers and a single codeword (e.g., codeword 0), the network entity 105 may map d⁽⁰⁾(2i) modulated symbols 315 to a first layer (e.g., Layer 0), represented by x⁽⁰⁾(i), and d⁽⁰⁾(2i+1) modulated symbols 315 to a second layer (e.g., Layer 1), represented by x⁽¹⁾(i). In other words, a codeword-to-layer mapping for two layers and a single codeword may result in the first layer being represented by x⁽⁰⁾(i)=d⁽⁰⁾(2i), and the second layer being represented by x⁽¹⁾(i)=d⁽⁰⁾(2i+1), where

$$i = 0 , 1 , … , {M}_{symb}^{layer} - 1 and {M}_{symb}^{layer} = {M}_{symb}^{( 0 )} / 2.$$

Additionally, the network entity 105 may map the block of vectors, [x⁽⁰⁾(i) . . . x^{(v-1)}(i)]^{T} to antenna ports (e.g., may map layers to antenna ports) according to the following Equation 3:

$$[ \begin{matrix}{y}^{( {p}_{0} )} ( i ) \\ M \\ {y}^{( {p}_{v - 1} )} ( i )\end{matrix} ] = [ \begin{matrix}{x}^{( 0 )} ( i ) \\ M \\ {x}^{( v - 1 )} ( i )\end{matrix} ] \qquad ( 3 )$$

where p₀ may represent an antenna port number (e.g., from a set of antenna ports {p₀, . . . , pᵥ₋₁}) and each of 0 and v−1 may represent a layer index (e.g., layer number). Each antenna port (e.g., and corresponding layer) may further correspond to a time-frequency grid 325, where each time-frequency grid 325 includes multiple REs 310 that are defined by a symbol 315 in the time domain and a subcarrier 320 in the frequency domain. That is, for the two layers, a first layer may correspond to a first antenna port, which may further correspond to a time-frequency grid 325-a and a second layer may correspond to a second antenna port, which may further correspond to a time-frequency grid 325-b. Thus, in accordance with the resource mapping diagram 300-a, the network entity 105 may map the modulated symbols 315, mapped to each layer (e.g., antenna port), to multiple subcarriers 320, where the multiple subcarriers 320 span a BWP 330. In other words, the network entity 105 may perform layer to time-frequency grid mapping. For example, for the two layers, the network entity 105 may map the d⁽⁰⁾(2i) modulated symbols 315 to a first set of subcarriers 320 spanning the BWP 330 in the time-frequency grid 325-a and may map the d⁽⁰⁾(2i+1) modulated symbols 315 to a second set of subcarriers 320 spanning the BWP 330 in the time-frequency grid 325-b. The network entity 105 may then map each set of subcarriers 320 to a respective set of symbols 315 (e.g., not shown) in accordance with the order of spatial domain first, then frequency domain second, then time domain third. However, as described with reference to FIG. 2, rate matching in accordance with the resource mapping diagram 300-a may result in decreased frequency diversity.

Accordingly, as described with reference to FIG. 2, the network entity 105 may support spatial layer-dependent frequency mapping for increased frequency diversity. That is, in accordance with the resource mapping diagram 300-b, the network entity 105 may perform rate matching in an order (e.g., a DCI resource mapping rule) of DCI codeword generation, spatial layer (e.g., spatial domain) mapping, spatial layer dependent frequency domain mapping, and then time domain mapping, for a multi-layer downlink transmission with DCI piggybacked on PDSCH. In other words, the network entity 105 may map each spatial layer (e.g., the first spatial layer and the second spatial layer) to a corresponding set of subcarriers 320 (e.g., frequency domain subcarriers).

For example, after generating a set of modulated symbols 315 of DCI for a codeword, q, as described with reference to Equation 1, the network entity 105 may map d⁽⁰⁾(i) modulated symbols 315 to the first layer (e.g., Layer 0), represented by x⁽⁰⁾(i), and d⁽⁰⁾(j) modulated symbols 315 to the second layer (e.g., Layer 1), represented by x⁽¹⁾(j). In other words, a codeword-to-layer mapping for two layers and two codewords may result in the first layer being represented by x⁽⁰⁾(i)=d⁽⁰⁾(i), and the second layer being represented by x⁽¹⁾(j)=d⁽⁰⁾(j), where i=0,1, . . . , N₀−1 and j=0,1, . . . , N₁−1. In such cases,

$${N}_{0} + {N}_{1} = {M}_{symb}^{( 0 )} , {N}_{0} \neq {N}_{1} ,$$

and a respective value of each of N₀ and N₁ may be based on a respective layer index (e.g., MIMO layer index). That is, for the first layer,

$${M}_{symb}^{layer} = {N}_{0}$$

and, for the second layer,

$${M}_{symb}^{layer} = {N}_{1} .$$

Thus, in accordance with the resource mapping diagram 300-b, the network entity 105 may map the modulated symbols 315, mapped to each layer (e.g., antenna port), to multiple subcarriers 320, where the multiple subcarriers 320 span a respective portion 335 of the BWP 330. For example, for the two layers, the network entity 105 may map the d⁽⁰⁾(i) modulated symbols 315 to a third set of subcarriers 320 spanning a portion 335-a of the BWP 330 in the time-frequency grid 325-a and may map the d⁽⁰⁾(j) modulated symbols 315 to a fourth set of subcarriers 320 spanning a portion 335-b of the BWP 330 in the time-frequency grid 325-b. In some cases, as depicted in FIG. 3, the portion 335-a may not overlap the portion 335-b in the frequency domain. In some other cases, the portion 335-a may at least partially overlap the portion 335-b. Additionally, or alternatively, the portion 335-a may span a first half of the BWP 330 and the portion 335-b may span a second half of the BWP 330. In other words, the network entity 105 may map the d⁽⁰⁾(i) modulated symbols 315 to the first half of the BWP 330 (e.g., PDSCH BWP 330) and may map the d⁽⁰⁾(j) modulated symbols 315 to the second half of the BWP 330.

Additionally, the network entity 105 may map each set of subcarriers 320 to a respective set of symbols 315 (e.g., not shown) in accordance with the order of spatial domain first, then frequency domain second, then time domain third. In some cases (e.g., since N₀≠N₁), the network entity 105 may perform zero padding to prevent, or avoid, inconsistencies between rows of a matrix (e.g., the block of vectors represented in accordance with Equation 2) for layer mapping. Additionally, or alternatively, N₀ may be equal to N₁. In such cases, the network entity 105 may map each layer to a respective portion 335 of the BWP 330 (e.g., of the PDSCH), where the respective portions 335 are at least partially (e.g., or fully) non-overlapping (e.g., the portion 335-a may not overlap the portion 335-b).

In some examples, a quantity of DCI codewords may be different from a quantity of data codewords (e.g., DL-SCH codewords). Thus, to enable the network entity to distribute coded bits evenly across layers, the network entity 105 may interleave the coded bits across different codewords. That is, after forming the DCI codewords (e.g., codewords for DCI components), a block interleaver at the network entity 105 may interleave the coded bits across different codewords (e.g., first) and the network entity 105 may map the interleaved coded bits in accordance with the techniques described herein (e.g., in accordance with the resource mapping diagram 300-b). In some cases, a configuration of the block interleaver may be preconfigured at the network entity 105 (e.g., hard coded), may depend on the quantity of DCI codewords, may depend on a quantity of coded bits within each DCI codeword, or any combination thereof.

In such cases, rate matching data REs (e.g., DL-SCH) around DCI REs 305 in accordance with the resource mapping diagram 300-b may result in increased frequency diversity (e.g., as compared to the resource mapping diagram 300-a) for DCI REs 305 due to each layer being mapped to different portions 335 of the BWP 330. Additionally, or alternatively, puncturing of the data REs with DCI REs 305 in accordance with the resource mapping diagram 300-b may result in increased performance (e.g., as compared to the resource mapping diagram 300-a) for the data REs due to not all data REs across all layers being punctured.

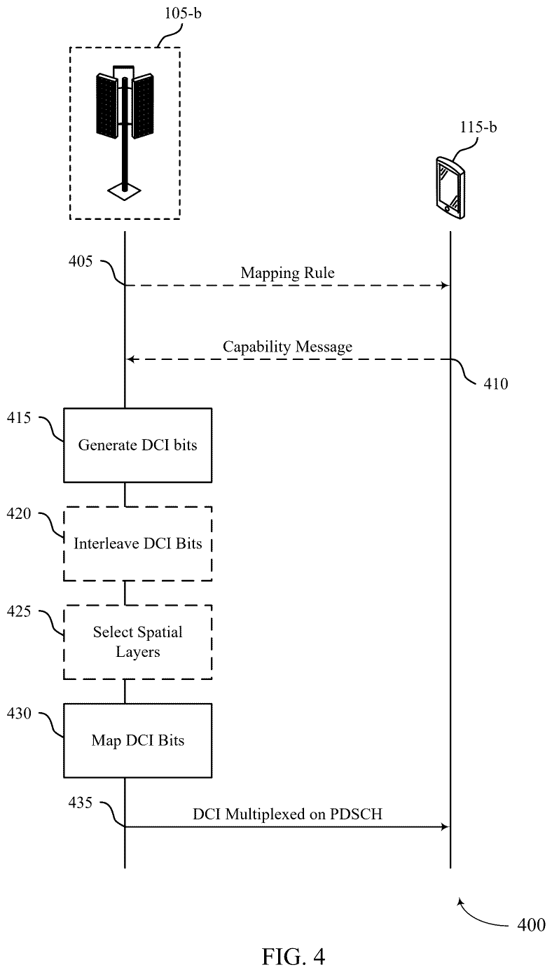

FIG. 4 shows an example of a process flow 400 that supports techniques for DCI piggybacking in multi-layer downlink MIMO in accordance with one or more aspects of the present disclosure. In some cases, the process flow 400 may implement or be implemented by aspects of the wireless communications system 100, the wireless communications system 200, the resource mapping diagrams 300, or any combination thereof. For example, the process flow may include one or more UEs 115 (e.g., a UE 115-b) and one or more network entities 105 (e.g., a network entity 105-b), which may be examples of the corresponding devices as described herein. In the following description of the process flow 400, the operations between the UE 115-b and the network entity 105-b may be communicated in a different order than the example order shown, or the operations performed by the UE 115-b and the network entity 105-b may be performed in different orders or at different times. Some operations may also be omitted from the process flow 400, and other operations may be added to the process flow 400.

In some cases, at 405, the network entity 105-b may transmit, to the UE 115-a (e.g., via RRC signaling or DCI signaling) an indication of a mapping rule associated with a first subset of a set of DCI bits being mapped to a first set of frequency resources and a second subset of the set of DCI bits being mapped to a second set of frequency resources.

In some examples, at 410, the UE 115-b may transmit, to the network entity 105-b, an indication (e.g., a capability message) of a capability of the UE 115-b to support the mapping rule. In some cases, the indication of the capability may be responsive to the indication of the mapping rule.

At 415, the network entity 105-b may generate the set of DCI bits. In some cases, the set of DCI bits may be associated with a set of first codewords (e.g., a single codeword or multiple codewords).

In some cases, at 420, the network entity 105-b may interleave the set of DCI bits across a set of second codewords associated with a downlink shared channel (e.g., PDSCH) to generate a set of interleaved downlink DCI bits. In some examples, the network entity 105-b may interleave the set of DCI bits based on a quantity of the first codewords, a quantity of DCI bits in each of the first codewords, or both. Additionally, or alternatively, a quantity of first codewords in the set of first codewords may be different than a quantity of second codewords in the set of second codewords.

In some cases, at 425, the network entity 105-b may select a subset of spatial layers from multiple spatial layers (e.g., associated with the downlink shared channel) based on the subset of spatial layers being associated with a set of strongest DMRS ports out of multiple DMRS ports associated with the multiple spatial layers.

At 430, the network entity 105-b may map, as part of a multiplexing procedure, the set of DCI bits (e.g., the set of interleaved DCI bits) onto the downlink shared channel such that the first subset of the set of DCI bits (e.g., a first subset of the set of interleaved DCI bits) is mapped to the first set of frequency resources associated with a first spatial layer of the multiple spatial layers and such that the second subset of the set of DCI bits (e.g., a second subset of the set of interleaved DCI bits) is mapped to the second set of frequency resources associated with a second spatial layer of the multiple spatial layers. In such cases, the mapping may be based on transmission of the indication of the mapping rule by the network entity 105-b, reception of the indication of the capability of the UE 115-b by the network entity 105-b, or both. In some cases, the first spatial layer and the second spatial layer may be the subset of the spatial layers. Additionally, or alternatively, a first quantity of bits in the first subset of the set of DCI bits may be equal to a second quantity of bits in the second subset of the set of DCI bits.

In such cases, the first set of frequency resources and the second set of frequency resources may be at least partially non-overlapping (e.g., may be non-overlapping). In some cases, the first set of frequency resources may be associated with a first portion (e.g., a first half) of BWP associated with the downlink shared channel, the second set of frequency resources may be associated with a second portion (e.g., a second half) of the BWP associated with the downlink shared channel, and the first set of frequency resources and the second set of frequency resources may at least partially non-overlapping based on the first portion of the bandwidth part and the second portion of the bandwidth part being at least partially non-overlapping.

In some examples, the network entity 105-b may refrain from mapping the set of DCI bits to one or more other spatial layers of the multiple spatial layers. Additionally, or alternatively, the network entity 105-b may map, as part of the multiplexing procedure, a third subset of the set of DCI bits to a third set of frequency resources associate with a third spatial layer of the multiple spatial layers, where the first set of frequency resources, the second set of frequency resources, and the third set of frequency resources are at least partially non-overlapping.

At 435, the network entity 105-b may transmit, via the downlink shared channel and via the multiple spatial layers, a message including the multiplexed set of DCI bits.

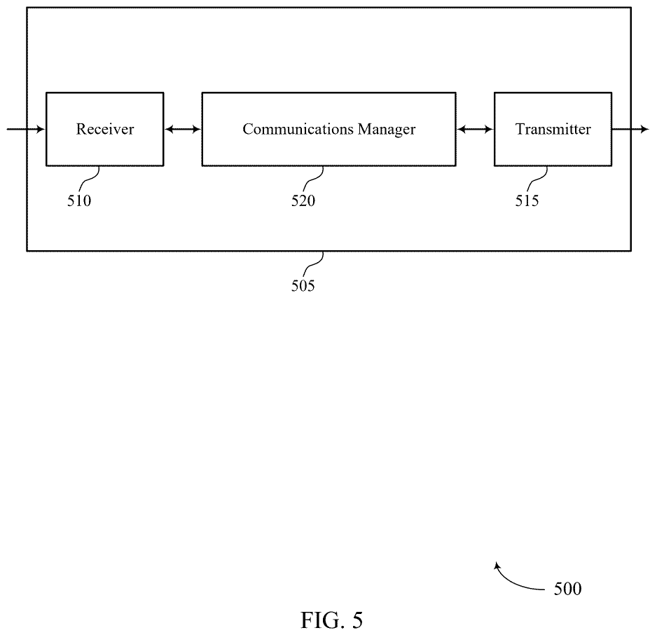

FIG. 5 shows a block diagram 500 of a device 505 that supports techniques for DCI piggybacking in multi-layer downlink MIMO in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of techniques for DCI piggybacking in multi-layer downlink MIMO as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for generating a set of downlink control information bits. The communications manager 520 is capable of, configured to, or operable to support a means for mapping, as part of a multiplexing procedure, the set of downlink control information bits onto a downlink sharing channel such that a first subset of the set of downlink control information bits is mapped to a first set of frequency resources associated with a first spatial layer of a set of multiple spatial layers and such that a second subset of the set of downlink control information bits is mapped to a second set of frequency resources associated with a second spatial layer of the set of multiple spatial layers, where the first set of frequency resources and the second set of frequency resources are at least partially non-overlapping. The communications manager 520 is capable of, configured to, or operable to support a means for transmitting, via the downlink shared channel and via the set of multiple spatial layers, a message including the multiplexed set of downlink control information bits.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for DCI piggybacking in multi-layer downlink MIMO, which may result in reduced processing, reduced power consumption, more efficient utilization of communication resources, among other advantages.

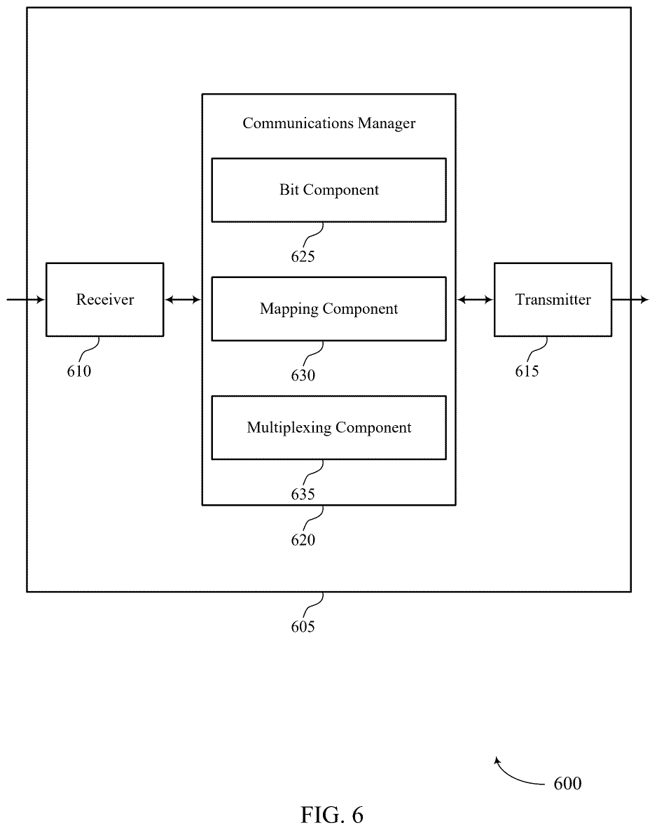

FIG. 6 shows a block diagram 600 of a device 605 that supports techniques for DCI piggybacking in multi-layer downlink MIMO in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of techniques for DCI piggybacking in multi-layer downlink MIMO as described herein. For example, the communications manager 620 may include a bit component 625, a mapping component 630, a multiplexing component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The bit component 625 is capable of, configured to, or operable to support a means for generating a set of downlink control information bits. The mapping component 630 is capable of, configured to, or operable to support a means for mapping, as part of a multiplexing procedure, the set of downlink control information bits onto a downlink shared channel such that a first subset of the set of downlink control information bits is mapped to a first set of frequency resources associated with a first spatial layer of a set of multiple spatial layers and such that a second subset of the set of downlink control information bits is mapped to a second set of frequency resources associated with a second spatial layer of the set of multiple spatial layers, where the first set of frequency resources and the second set of frequency resources are at least partially non-overlapping. The multiplexing component 635 is capable of, configured to, or operable to support a means for transmitting, via the downlink shared channel and via the set of multiple spatial layers, a message including the multiplexed set of downlink control information bits.

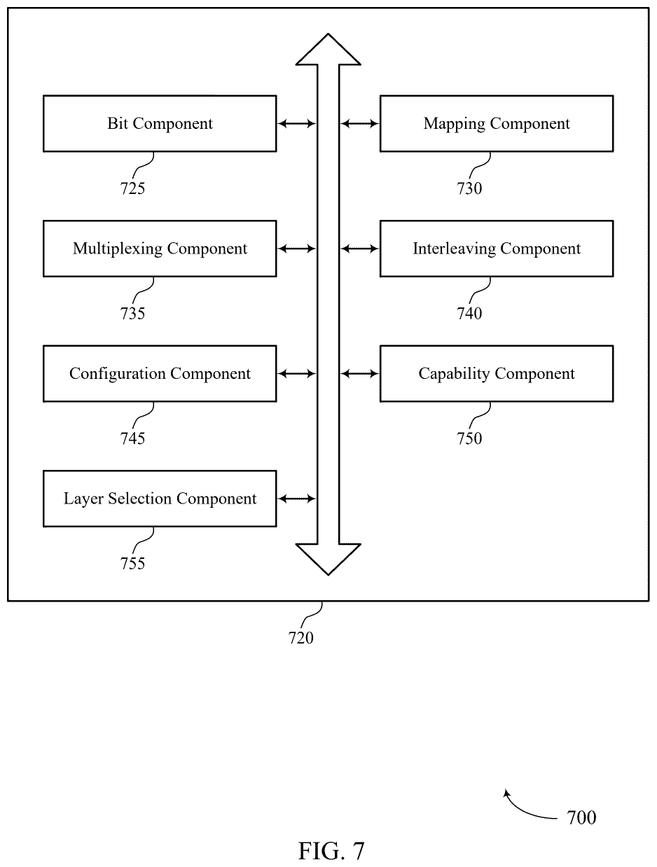

FIG. 7 shows a block diagram 700 of a communications manager 720 that supports techniques for DCI piggybacking in multi-layer downlink MIMO in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for DCI piggybacking in multi-layer downlink MIMO as described herein. For example, the communications manager 720 may include a bit component 725, a mapping component 730, a multiplexing component 735, an interleaving component 740, a configuration component 745, a capability component 750, a layer selection component 755, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The bit component 725 is capable of, configured to, or operable to support a means for generating a set of downlink control information bits. The mapping component 730 is capable of, configured to, or operable to support a means for mapping, as part of a multiplexing procedure, the set of downlink control information bits onto a downlink shared channel such that a first subset of the set of downlink control information bits is mapped to a first set of frequency resources associated with a first spatial layer of a set of multiple spatial layers and such that a second subset of the set of downlink control information bits is mapped to a second set of frequency resources associated with a second spatial layer of the set of multiple spatial layers, where the first set of frequency resources and the second set of frequency resources are at least partially non-overlapping. The multiplexing component 735 is capable of, configured to, or operable to support a means for transmitting, via the downlink shared channel and via the set of multiple spatial layers, a message including the multiplexed set of downlink control information bits.

In some examples, the first set of frequency resources are associated with a first portion of a bandwidth part associated with the downlink shared channel. In some examples, the second set of frequency resources are associated with a second portion of the bandwidth part associated with the downlink shared channel. In some examples, the first set of frequency resources and the second set of frequency resources are at least partially non-overlapping based on the first portion of the bandwidth part and the second portion of the bandwidth part being at least partially non-overlapping.

In some examples, the first portion is a first half of the bandwidth part. In some examples, the second portion is a second half of the bandwidth part.

In some examples, the set of downlink control information bits are associated with a set of multiple first codewords, and the interleaving component 740 is capable of, configured to, or operable to support a means for interleaving the set of downlink control information bits across a set of multiple second codewords associated with the downlink shared channel to generate a set of interleaved downlink control information bits, where the first subset of the set of downlink control information bits includes a first subset of the set of interleaved downlink control information bits, and where the second subset of the set of downlink control information bits includes a second subset of the set of interleaved downlink control information bits.

In some examples, the set of downlink control information bits being interleaved is based on a quantity of first codewords in the set of multiple first codewords, a quantity of downlink control information bits in each of the set of multiple first codewords, or both.

In some examples, a quantity of first codewords in the set of multiple first codewords is different than a quantity of second codewords in the set of multiple second codewords.

In some examples, the set of multiple spatial layers are associated with the downlink shared channel. In some examples, the first spatial layer and the second spatial layer include a subset of spatial layers from the set of multiple spatial layers.

In some examples, the layer selection component 755 is capable of, configured to, or operable to support a means for selecting the subset of spatial layers from the set of multiple spatial layers based on the subset of spatial layers being associated with a set of strongest demodulation reference signal ports out of a set of multiple demodulation reference signal ports associated with the set of multiple spatial layers.

In some examples, the mapping component 730 is capable of, configured to, or operable to support a means for refraining from mapping the set of downlink control information bits to one or more other spatial layers of the set of multiple spatial layers.

In some examples, the configuration component 745 is capable of, configured to, or operable to support a means for transmitting an indication of a mapping rule associated with the first subset of the set of downlink control information bits being mapped to the first set of frequency resources and the second subset of the set of downlink control information bits being mapped to the second set of frequency resources, where the first subset of the set of downlink control information bits is mapped to the first set of frequency resources and the second subset of the set of downlink control information bits is mapped to the second set of frequency resources is based on transmission of the indication.

In some examples, the indication of the mapping rule is transmitted via radio resource control signaling or downlink control information signaling.

In some examples, the capability component 750 is capable of, configured to, or operable to support a means for receiving an indication of a capability of a UE to support a mapping rule associated with the first subset of the set of downlink control information bits being mapped to the first set of frequency resources and the second subset of the set of downlink control information bits being mapped to the second set of frequency resources, where the first subset of the set of downlink control information bits is mapped to the first set of frequency resources and the second subset of the set of downlink control information bits is mapped to the second set of frequency resources is based on the capability of the UE.

In some examples, the mapping component 730 is capable of, configured to, or operable to support a means for mapping, as part of the multiplexing procedure, a third subset of the set of downlink control information bits to a third set of frequency resources associated with a third spatial layer of the set of multiple spatial layers, where the first set of frequency resources, the second set of frequency resources, and the third set of frequency resources are at least partially non-overlapping.

In some examples, the first set of frequency resources and the second set of frequency resources are non-overlapping.

In some examples, the set of downlink control information bits are associated with a single codeword or multiple codewords.

In some examples, a first quantity of bits in the first subset of the set of downlink control information bits is equal to a second quantity of bits in the second subset of the set of downlink control information bits.

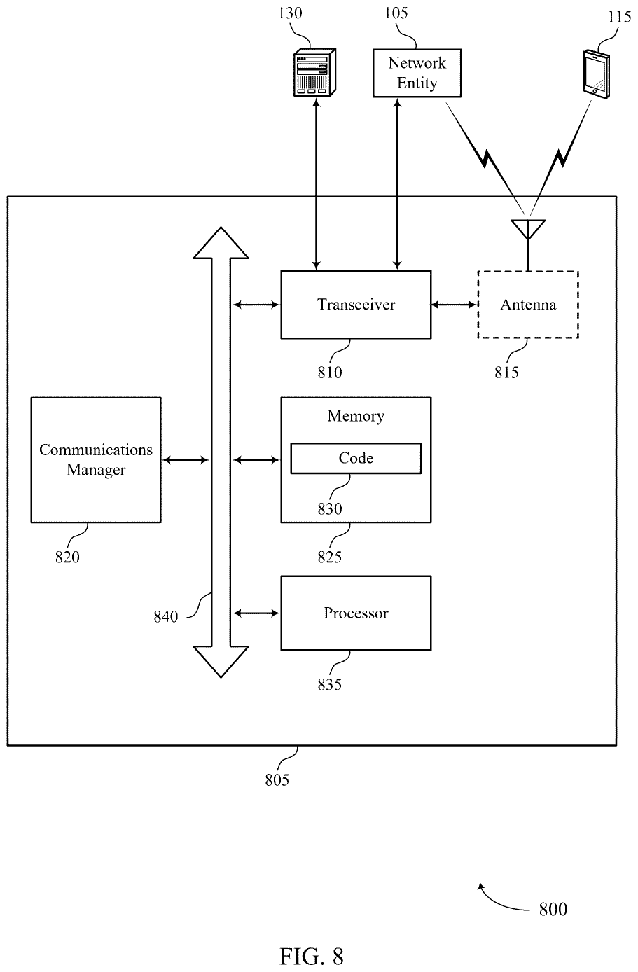

FIG. 8 shows a diagram of a system 800 including a device 805 that supports techniques for DCI piggybacking in multi-layer downlink MIMO in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting techniques for DCI piggybacking in multi-layer downlink MIMO). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for generating a set of downlink control information bits. The communications manager 820 is capable of, configured to, or operable to support a means for mapping, as part of a multiplexing procedure, the set of downlink control information bits onto a downlink sharing channel such that a first subset of the set of downlink control information bits is mapped to a first set of frequency resources associated with a first spatial layer of a set of multiple spatial layers and such that a second subset of the set of downlink control information bits is mapped to a second set of frequency resources associated with a second spatial layer of the set of multiple spatial layers, where the first set of frequency resources and the second set of frequency resources are at least partially non-overlapping. The communications manager 820 is capable of, configured to, or operable to support a means for transmitting, via the downlink shared channel and via the set of multiple spatial layers, a message including the multiplexed set of downlink control information bits.

By including or configuring the communications manager 820 in accordance with examples as described herein, the device 805 may support techniques for DCI piggybacking in multi-layer downlink MIMO, which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of techniques for DCI piggybacking in multi-layer downlink MIMO as described herein, or the at least one processor 835 and the at least one memory 825 may be otherwise configured to, individually or collectively, perform or support such operations.

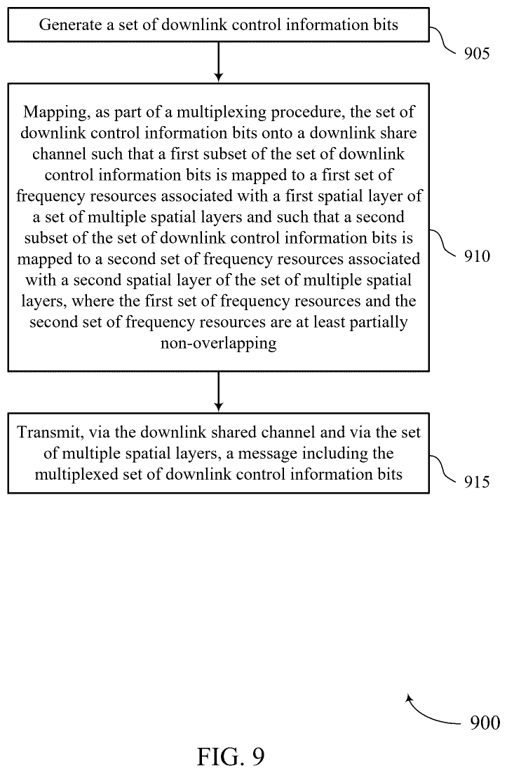

FIG. 9 shows a flowchart illustrating a method 900 that supports techniques for DCI piggybacking in multi-layer downlink MIMO in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include generating a set of downlink control information bits. The operations of 905 may be performed in accordance with examples as disclosed herein. In some examples, aspects of the operations of 905 may be performed by a bit component 725 as described with reference to FIG. 7.

At 910, the method may include mapping, as part of a multiplexing procedure, the set of downlink control information bits onto a downlink shared channel such that a first subset of the set of downlink control information bits is mapped to a first set of frequency resources associated with a first spatial layer of a set of multiple spatial layers and such that a second subset of the set of downlink control information bits is mapped to a second set of frequency resources associated with a second spatial layer of the set of multiple spatial layers, where the first set of frequency resources and the second set of frequency resources are at least partially non-overlapping. The operations of 910 may be performed in accordance with examples as disclosed herein. In some examples, aspects of the operations of 910 may be performed by a mapping component 730 as described with reference to FIG. 7.

At 915, the method may include transmitting, via the downlink shared channel and via the set of multiple spatial layers, a message including the multiplexed set of downlink control information bits. The operations of 915 may be performed in accordance with examples as disclosed herein. In some examples, aspects of the operations of 915 may be performed by a multiplexing component 735 as described with reference to FIG. 7.

The following provides an overview of aspects of the present disclosure:

Aspect 1: A method for wireless communications at a network entity, comprising: generating a set of DCI bits; mapping, as part of a multiplexing procedure, the set of DCI bits onto a downlink shared channel such that a first subset of the set of DCI bits is mapped to a first set of frequency resources associated with a first spatial layer of a plurality of spatial layers and such that a second subset of the set of DCI bits is mapped to a second set of frequency resources associated with a second spatial layer of the plurality of spatial layers, wherein the first set of frequency resources and the second set of frequency resources are at least partially non-overlapping; and transmitting, via the downlink shared channel and via the plurality of spatial layers, a message comprising the multiplexed set of DCI bits.

Aspect 2: The method of aspect 1, wherein the first set of frequency resources are associated with a first portion of a BWP associated with the downlink shared channel, the second set of frequency resources are associated with a second portion of the BWP associated with the downlink shared channel, and the first set of frequency resources and the second set of frequency resources are at least partially non-overlapping based at least in part on the first portion of the BWP and the second portion of the BWP being at least partially non-overlapping.

Aspect 3: The method of aspect 2, wherein the first portion is a first half of the BWP, and the second portion is a second half of the BWP.

Aspect 4: The method of any of aspects 1 through 3, wherein the set of DCI bits are associated with a plurality of first codewords, the method further comprising: interleaving the set of DCI bits across a plurality of second codewords associated with the downlink shared channel to generate a set of interleaved DCI bits, wherein the first subset of the set of DCI bits comprises a first subset of the set of interleaved DCI bits, and wherein the second subset of the set of DCI bits comprises a second subset of the set of interleaved DCI bits.

Aspect 5: The method of aspect 4, wherein the set of DCI bits being interleaved is based at least in part on a quantity of first codewords in the plurality of first codewords, a quantity of DCI bits in each of the plurality of first codewords, or both.

Aspect 6: The method of any of aspects 4 through 5, wherein a quantity of first codewords in the plurality of first codewords is different than a quantity of second codewords in the plurality of second codewords.

Aspect 7: The method of any of aspects 1 through 6, wherein the plurality of spatial layers are associated with the downlink shared channel, and the first spatial layer and the second spatial layer comprise a subset of spatial layers from the plurality of spatial layers.

Aspect 8: The method of aspect 7, further comprising: selecting the subset of spatial layers from the plurality of spatial layers based at least in part on the subset of spatial layers being associated with a set of strongest demodulation reference signal ports out of a plurality of demodulation reference signal ports associated with the plurality of spatial layers.

Aspect 9: The method of any of aspects 7 through 8, further comprising: refraining from mapping the set of DCI bits to one or more other spatial layers of the plurality of spatial layers.

Aspect 10: The method of any of aspects 1 through 9, further comprising: transmitting an indication of a mapping rule associated with the first subset of the set of DCI bits being mapped to the first set of frequency resources and the second subset of the set of DCI bits being mapped to the second set of frequency resources, wherein the first subset of the set of DCI bits is mapped to the first set of frequency resources and the second subset of the set of DCI bits is mapped to the second set of frequency resources is based at least in part on transmission of the indication.

Aspect 11: The method of aspect 10, wherein the indication of the mapping rule is transmitted via radio resource control signaling or downlink control information signaling.

Aspect 12: The method of any of aspects 1 through 11, further comprising: receiving an indication of a capability of a UE to support a mapping rule associated with the first subset of the set of DCI bits being mapped to the first set of frequency resources and the second subset of the set of DCI bits being mapped to the second set of frequency resources, wherein the first subset of the set of DCI bits is mapped to the first set of frequency resources and the second subset of the set of DCI bits is mapped to the second set of frequency resources is based at least in part on the capability of the UE.

Aspect 13: The method of any of aspects 1 through 12, further comprising: mapping, as part of the multiplexing procedure, a third subset of the set of DCI bits toa third set of frequency resources associated with a third spatial layer of the plurality of spatial layers, wherein the first set of frequency resources, the second set of frequency resources, and the third set of frequency resources are at least partially non-overlapping.

Aspect 14: The method of any of aspects 1 through 13, wherein the first set of frequency resources and the second set of frequency resources are non-overlapping.

Aspect 15: The method of any of aspects 1 through 14, wherein the set of DCI bits are associated with a single codeword or multiple codewords.

Aspect 16: The method of any of aspects 1 through 15, wherein a first quantity of bits in the first subset of the set of DCI bits is equal to a second quantity of bits in the second subset of the set of DCI bits.

Aspect 17: A network entity for wireless communications, comprising one or more memories storing processor-executable code, and one or more processors coupled with the one or more memories and individually or collectively operable to execute the code to cause the network entity to perform a method of any of aspects 1 through 16.

Aspect 18: A network entity for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
generate a set of downlink control information bits;
mapping, as part of a multiplexing procedure, the set of downlink control information bits onto a downlink shared channel such that a first subset of the set of downlink control information bits is mapped to a first set of frequency resources associated with a first spatial layer of a plurality of spatial layers and such that a second subset of the set of downlink control information bits is mapped to a second set of frequency resources associated with a second spatial layer of the plurality of spatial layers, wherein the first set of frequency resources and the second set of frequency resources are at least partially non-overlapping; and
transmit, via the downlink shared channel and via the plurality of spatial layers, a message comprising the multiplexed set of downlink control information bits.

2. The network entity of claim 1, wherein the first set of frequency resources are associated with a first portion of a bandwidth part associated with the downlink shared channel, wherein the second set of frequency resources are associated with a second portion of the bandwidth part associated with the downlink shared channel, and wherein the first set of frequency resources and the second set of frequency resources are at least partially non-overlapping based at least in part on the first portion of the bandwidth part and the second portion of the bandwidth part being at least partially non-overlapping.

3. The network entity of claim 2, wherein the first portion is a first half of the bandwidth part, and wherein the second portion is a second half of the bandwidth part.

4. The network entity of claim 1, wherein the set of downlink control information bits are associated with a plurality of first codewords, and the one or more processors are individually or collectively further operable to execute the code to cause the network entity to:
interleave the set of downlink control information bits across a plurality of second codewords associated with the downlink shared channel to generate a set of interleaved downlink control information bits, wherein the first subset of the set of downlink control information bits comprises a first subset of the set of interleaved downlink control information bits, and wherein the second subset of the set of downlink control information bits comprises a second subset of the set of interleaved downlink control information bits.

5. The network entity of claim 4, wherein the set of downlink control information bits being interleaved is based at least in part on a quantity of first codewords in the plurality of first codewords, a quantity of downlink control information bits in each of the plurality of first codewords, or both.

6. The network entity of claim 4, wherein a quantity of first codewords in the plurality of first codewords is different than a quantity of second codewords in the plurality of second codewords.

7. The network entity of claim 1, wherein the plurality of spatial layers are associated with the downlink shared channel, and wherein the first spatial layer and the second spatial layer comprise a subset of spatial layers from the plurality of spatial layers.

8. The network entity of claim 7, wherein the one or more processors are individually or collectively further operable to execute the code to cause the network entity to:
select the subset of spatial layers from the plurality of spatial layers based at least in part on the subset of spatial layers being associated with a set of strongest demodulation reference signal ports out of a plurality of demodulation reference signal ports associated with the plurality of spatial layers.

9. The network entity of claim 7, wherein the one or more processors are individually or collectively further operable to execute the code to cause the network entity to:
refrain from mapping the set of downlink control information bits to one or more other spatial layers of the plurality of spatial layers.

10. The network entity of claim 1, wherein the one or more processors are individually or collectively further operable to execute the code to cause the network entity to:
transmit an indication of a mapping rule associated with the first subset of the set of downlink control information bits being mapped to the first set of frequency resources and the second subset of the set of downlink control information bits being mapped to the second set of frequency resources, wherein the first subset of the set of downlink control information bits is mapped to the first set of frequency resources and the second subset of the set of downlink control information bits is mapped to the second set of frequency resources is based at least in part on transmission of the indication.

11. The network entity of claim 10, wherein the indication of the mapping rule is transmitted via radio resource control signaling or downlink control information signaling.

12. The network entity of claim 1, wherein the one or more processors are individually or collectively further operable to execute the code to cause the network entity to:
receive an indication of a capability of a user equipment (UE) to support a mapping rule associated with the first subset of the set of downlink control information bits being mapped to the first set of frequency resources and the second subset of the set of downlink control information bits being mapped to the second set of frequency resources, wherein the first subset of the set of downlink control information bits is mapped to the first set of frequency resources and the second subset of the set of downlink control information bits is mapped to the second set of frequency resources is based at least in part on the capability of the UE.

13. The network entity of claim 1, wherein the one or more processors are individually or collectively further operable to execute the code to cause the network entity to:
mapping, as part of the multiplexing procedure, a third subset of the set of downlink control information bits to a third set of frequency resources associate with a third spatial layer of the plurality of spatial layers, wherein the first set of frequency resources, the second set of frequency resources, and the third set of frequency resources are at least partially non-overlapping.

14. The network entity of claim 1, wherein the first set of frequency resources and the second set of frequency resources are non-overlapping.

15. The network entity of claim 1, wherein the set of downlink control information bits are associated with a single codeword or multiple codewords.

16. The network entity of claim 1, wherein a first quantity of bits in the first subset of the set of downlink control information bits is equal to a second quantity of bits in the second subset of the set of downlink control information bits.

17. A method for wireless communications at a network entity, comprising:
generating a set of downlink control information bits;
mapping, as part of a multiplexing procedure, the set of downlink control information bits onto a downlink shared channel such that a first subset of the set of downlink control information bits is mapped to a first set of frequency resources associated with a first spatial layer of a plurality of spatial layers and such that a second subset of the set of downlink control information bits is mapped to a second set of frequency resources associated with a second spatial layer of the plurality of spatial layers, wherein the first set of frequency resources and the second set of frequency resources are at least partially non-overlapping; and
transmitting, via the downlink shared channel and via the plurality of spatial layers, a message comprising the multiplexed set of downlink control information bits.

18. The method of claim 17, wherein the first set of frequency resources are associated with a first portion of a bandwidth part associated with the downlink shared channel, wherein the second set of frequency resources are associated with a second portion of the bandwidth part associated with the downlink shared channel, and wherein the first set of frequency resources and the second set of frequency resources are at least partially non-overlapping based at least in part on the first portion of the bandwidth part and the second portion of the bandwidth part being at least partially non-overlapping.

19. The method of claim 17, wherein the set of downlink control information bits are associated with a plurality of first codewords, the method further comprising:
interleaving the set of downlink control information bits across a plurality of second codewords associated with the downlink shared channel to generate a set of interleaved downlink control information bits, wherein the first subset of the set of downlink control information bits comprises a first subset of the set of interleaved downlink control information bits, and wherein the second subset of the set of downlink control information bits comprises a second subset of the set of interleaved downlink control information bits.

20. A network entity for wireless communications, comprising:
means for generating a set of downlink control information bits;
means for mapping, as part of a multiplexing procedure, the set of downlink control information bits onto a downlink shared channel such that a first subset of the set of downlink control information bits is mapped to a first set of frequency resources associated with a first spatial layer of a plurality of spatial layers and such that a second subset of the set of downlink control information bits is mapped to a second set of frequency resources associated with a second spatial layer of the plurality of spatial layers, wherein the first set of frequency resources and the second set of frequency resources are at least partially non-overlapping; and
means for transmitting, via the downlink shared channel and via the plurality of spatial layers, a message comprising the multiplexed set of downlink control information bits.
